(19) United States
(12) Patent Application Publication
(10) Pub. No.: US 2026/0278994 A1
(43) Pub. Date: Sep. 17, 2026

(54) IMAGE SEGMENTATION METHOD AND APPARATUS, MEDIUM, AND ELECTRONIC DEVICE

(71) Applicants: Beijing Zitiao Network Technology Co., Ltd., Beijing (CN); Lemon Inc., Grand Cayman (KY)

(72) Inventors: Zihao WANG, Beijing (CN); Yabo ZHANG, Beijing (CN); Jun Hao LIEW, Singapore (SG); Jiashi FENG, Singapore (SG); Manyu ZHU, Beijing (CN); Jingjia HUANG, Beijing (CN)

(21) Appl. No.: 19/473,088

(22) PCT Filed: Mar. 13, 2024
(86) PCT No.: PCT/CN2024/081474

§ 371 Date: Oct. 6, 2025

(30) Foreign Application Priority Data
Apr. 13, 2023 (CN) 202310400232.5

(51) Int. Cl. G06V 10/26; G06V 10/762; G06V 10/764; G06V 10/77; G06V 10/776

(52) U.S. Cl. CPC G06V 10/267; G06V 10/762; G06V 10/764; G06V 10/7715; G06V 10/776

(57) ABSTRACT

The present disclosure relates to an image segmentation method and apparatus, a medium, and an electronic device, belonging to the field of computer technologies, which can effectively alleviate the dependence of a segmentation task on manual pixel-level fine annotation, ensure accurate image semantic segmentation, and solve the problems of excessive noise in a segmented image and inaccurate boundaries. The image segmentation method includes: receiving an image to be segmented input by a user and a text description for the image to be segmented; clustering, by using a clustering module in an image semantic segmentation model, regions having a spatial similarity relationship in the image to be segmented to obtain clustering regions; and obtaining a segmentation result by using a segmentation module in the image semantic segmentation model based on the text description, the image to be segmented, and the clustering regions.

The present application claims priority to Chinese Patent Application No. 202310400232.5, filed with the China National Intellectual Property Administration on Apr. 13, 2023 and entitled “PICTURE SEGMENTATION METHOD AND APPARATUS, MEDIUM, AND ELECTRONIC DEVICE”, the disclosure of which is incorporated herein by reference in its entirety.

### FIELD

The present disclosure relates to the field of computer technologies, and in particular, to an image segmentation method and apparatus, a medium, and an electronic device.

### BACKGROUND

In the related art, most image semantic segmentation technologies use an “encoder-decoder” structure. After an image is input, an encoder encodes the input image into an image vector in a specific feature space, a decoder decodes the image vector output from the encoder and performs pixel-level classification thereon, and a classification result of each pixel is a class of image semantic segmentation. As shown in FIG. 1, the left image is an original image, an encoder encodes the left image to obtain an image vector, a decoder decodes the image vector and performs classification thereon, and the right image is an output result. In the right image, number 1 indicates a pixel classified as a “background class”, and number 2 indicates a pixel classified as an “airplane class”.

The segmentation granularity and the number of segmentation classes in the above image semantic segmentation technologies both depend on manually annotated data, which makes it difficult to flexibly apply the image semantic segmentation technologies on a large scale.

### SUMMARY

The summary is provided to give a brief overview of concepts, which will be described in detail in the following detailed description of embodiments. The summary is neither intended to identify key or necessary features of the claimed technical solutions, nor is it intended to be used to limit the scope of the claimed technical solutions.

According to a first aspect, the present disclosure provides an image segmentation method, including: receiving an image to be segmented input by a user and a text description for the image to be segmented; clustering, by using a clustering module in an image semantic segmentation model, regions having a spatial similarity relationship in the image to be segmented to obtain clustering regions; and obtaining a segmentation result by using a segmentation module in the image semantic segmentation model based on the text description, the image to be segmented, and the clustering regions.

According to a second aspect, the present disclosure provides an image segmentation apparatus, including: a receiving unit configured to receive an image to be segmented input by a user and a text description for the image to be segmented; a clustering unit configured to cluster, by using a clustering module in an image semantic segmentation model, regions having a spatial similarity relationship in the image to be segmented to obtain clustering regions; and a segmentation unit configured to obtain a segmentation result by using a segmentation module in the image semantic segmentation model based on the text description, the image to be segmented, and the clustering regions.

According to a third aspect, the present disclosure provides a computer-readable medium having a computer program stored thereon, where the program, when executed by a processing apparatus, causes the steps of the method according to any implementation of the first aspect of the present disclosure to be implemented.

According to a fourth aspect, the present disclosure provides an electronic device, including: a storage having a computer program stored thereon; and a processing apparatus configured to execute the computer program in the storage, to implement the steps of the method according to any implementation of the first aspect of the present disclosure.

### BRIEF DESCRIPTION OF THE DRAWINGS

The foregoing and other features, advantages, and aspects of embodiments of the present disclosure become more apparent with reference to the following specific implementations and accompanying drawings. Throughout the accompanying drawings, the same or similar reference numerals denote the same or similar elements. It should be understood that the accompanying drawings are schematic and that parts and elements are not necessarily drawn to scale. In the accompanying drawings:

FIG. 1 is a schematic diagram of image semantic segmentation according to the related art;

FIG. 2 is a flowchart of an image segmentation method according to an embodiment of the present disclosure;

FIG. 3 is a flowchart of training a clustering module in an image semantic segmentation model according to an embodiment of the present disclosure;

FIG. 4 is a schematic diagram of a clustering result of a clustering module according to an embodiment of the present disclosure;

FIG. 5 is a flowchart of training a segmentation module in an image semantic segmentation model according to an embodiment of the present disclosure;

FIG. 6 is a schematic diagram of unidirectionally matching phrases with clustering regions according to an embodiment of the present disclosure;

FIG. 7 is a schematic diagram of an image segmentation result according to an embodiment of the present disclosure;

FIG. 8 is another schematic diagram of an image segmentation result according to an embodiment of the present disclosure;

FIG. 9 is a schematic block diagram of an image segmentation apparatus according to an embodiment of the present disclosure; and

FIG. 10 is a schematic diagram of a structure of an electronic device suitable for implementing an embodiment of the present disclosure.

### DETAILED DESCRIPTION OF EMBODIMENTS

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It is to be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user may independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It is to be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

Furthermore, it is to be understood that the data involved in the technical solutions (including, but not limited to, the data itself and the access to or use of the data) shall comply with the requirements of corresponding laws, regulations, and relevant provisions.

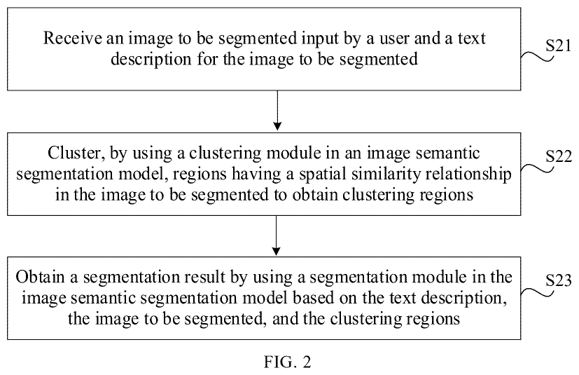

FIG. 2 is a flowchart of an image segmentation method according to an embodiment of the present disclosure. As shown in FIG. 2, the image segmentation method includes the following steps S21 to S23.

In step S21, an image to be segmented input by a user and a text description for the image to be segmented are received.

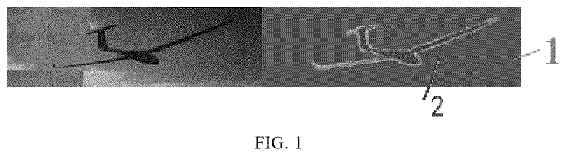

An example in which the image to be segmented is the left image in FIG. 1 is used. A user may input the image to be segmented and a text description for the image to be segmented, and for example, the text description may be “an airplane is flying”.

In step S22, regions having a spatial similarity relationship in the image to be segmented are clustered by using a clustering module in an image semantic segmentation model to obtain clustering regions.

The “regions having a spatial similarity relationship” are regions having spatially similar image content in the image. For example, if image content at a spatial coordinate 1 involves the head of a cat and image content at a spatial coordinate 2 involves the tail of a cat in the image, the spatial coordinate 1 and the spatial coordinate 2 are considered as regions having a spatial similarity relationship.

In the process of performing clustering by the clustering module, the clustering module may first encode the image to be segmented to obtain image features, and then the clustering module clusters the image features based on a spatial similarity between the image features to obtain the clustering regions of the image to be segmented.

In step S23, a segmentation result is obtained by using a segmentation module in the image semantic segmentation model based on the text description, the image to be segmented, and the clustering regions.

In the process of performing segmentation by the segmentation module, the segmentation module may first encode the image to be segmented to obtain image features indexed with spatial coordinates of the image to be segmented, and obtain a clustering feature of each of the clustering regions based on the image features. For example, a mean value or a root-mean-square value of image features that are located in the same clustering region among the image features obtained through encoding is calculated to obtain a clustering feature of each of the clustering regions. In addition, the segmentation module further extracts phrases (e.g., nouns) from the text description, and encodes each of the phrases to obtain a text feature of each of the phrases. Then, the segmentation module may unidirectionally match the text feature with each clustering feature. That is, for each text feature, a cross-entropy loss between the text feature and the clustering feature is calculated, and a clustering feature matching most closely with the text feature is determined based on the cross-entropy loss, to determine a clustering region matching most closely with each phrase and obtain a final segmentation result.

The above technical solution has the following beneficial effects.
(1) Regions having a spatial similarity relationship in an image to be segmented are clustered into one class first, and then image-text segmentation is performed based on a clustering result, thereby effectively using spatial consistency clustering information in the image to be segmented, which can ensure accurate image semantic segmentation, solve the problems of excessive noise in a segmented image and inaccurate boundaries, and effectively alleviate the dependence of a segmentation task on manual pixel-level fine annotation, so that an image semantic segmentation model can be scaled up for self-supervised training through a larger data set, improving the generalization performance of the image semantic segmentation model while reducing labor costs, and downstream application deployment is not limited to limited scenarios of manual annotation, enabling more flexible large-scale application.
(2) Benefitting by segmentation in the form of “image-text”, open vocabulary segmentation can be supported, and a segmentation result may be returned for any natural language input by a user.

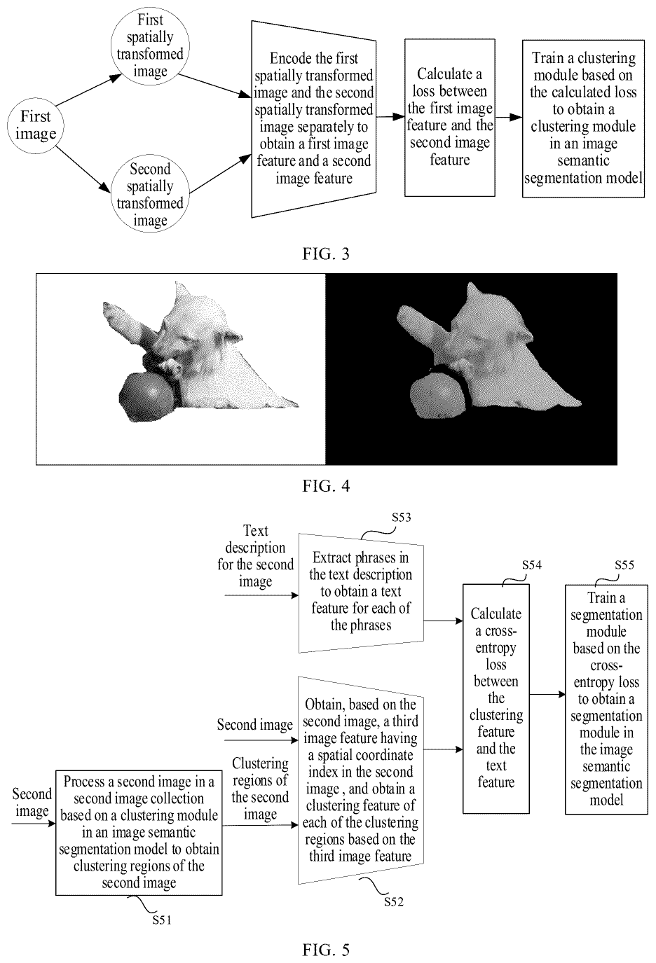

In some embodiments, the clustering module in the image semantic segmentation model is a module for clustering regions having a spatial similarity relationship in an image into one class. FIG. 3 is a flowchart of training a clustering module in an image semantic segmentation model according to an embodiment of the present disclosure.

As shown in FIG. 3, first, spatial transformation is performed on a first image I in a first image collection to obtain a first spatially transformed image In and a second spatially transformed image I₂.

The first image collection is a collection including a plurality of first images I. In this step, spatial transformation may be performed on each first image I in the first image collection. For example, spatial transformation is performed on a 1^{st} first image I to obtain a first spatially transformed image corresponding to the 1^{st} first image I and a second spatially transformed image corresponding to the 1^{st} first image I; and spatial transformation is performed on an N^{th} first image I to obtain a first spatially transformed image corresponding to the N^{th} first image I and a second spatially transformed image corresponding to the N^{th} first image I, etc.

The spatial transformation may include, for example, stretching, mirroring, cropping, color transformation, etc. The spatial transformation may be multi-scale and reversible.

For example, one of the first images I in the first image collection is stretched to obtain a first spatially transformed image I₁, and color transformation is performed on the same first image I to obtain a second spatially transformed image I₂. For another example, one of the first images I in the first image collection is stretched to obtain a first spatially transformed image I₁, and the same first image I is stretched again at the same scale to obtain a second spatially transformed image I₂. For another example, one of the first images I in the first image collection is stretched at a first scale to obtain a first spatially transformed image I₁, and the same first image I is stretched at a second scale to obtain a second spatially transformed image I₂. That is, a first spatially transformed image I₁ and a second spatially transformed image I₂ can be obtained by performing different spatial transformation operations (for example, for two spatial transformation operations, one is a stretching operation, and the other is a color transformation operation; for two spatial transformation operations, one is a mirroring operation, and the other is a cropping operation; for two spatial transformation operations, one is a first-scale stretching operation, and the other is a second-scale stretching operation, etc.) or the same spatial transformation operations (for example, two spatial transformation operations are both first-scale stretching operations; two spatial transformation operations are both the same color transformation operations, etc.) on the same first image I.

Then, the first spatially transformed image I₁ is encoded to obtain a first image feature, and the second spatially transformed image I₂ is encoded to obtain a second image feature. In some embodiments, the same image encoder may be used to encode the first spatially transformed image I₁ and the second spatially transformed image I₂ separately. In some examples, the first spatially transformed image I₁ and the second spatially transformed image I₂ may be encoded separately to obtain the first image feature and the second image feature that are both indexed with spatial coordinates in the first image I.

Then, a spatial consistency loss function (i.e., a self-supervised learning loss function for spatial consistency) is used to calculate a loss between the first image feature and the second image feature.

For example, if the first image feature and the second image feature both have a spatial coordinate index in the first image I, a spatial consistency loss function may be used to calculate a loss between image features that have the same spatial coordinate index among the first image features and the second image features. That is, the image features that have the same spatial coordinate index among the first image features and the second image features are made corresponding to each other, and a cross-entropy loss between these corresponding image features is calculated.

The purpose of calculating the loss between the first image feature and the second image feature is to ensure that features that correspond to the same location in the first image I among the first image features and the second image features are as consistent as possible. For example, it is assumed that a spatial coordinate index corresponding to a feature 1 among the first image features is an index 1, and a spatial coordinate index corresponding to a feature 2 among the second image features is also the index 1, which indicates that the feature 1 and the feature 2 correspond to the same location in the first image I. A spatial consistency loss is calculated to ensure that the feature 1 and the feature 2 are as consistent as possible.

Then, a clustering module is trained based on the calculated loss to obtain the clustering module in the image semantic segmentation model.

In some embodiments, the clustering module may be trained by minimizing the cross-entropy loss between the image features that have the same spatial coordinate index among the first image features and the second image features.

Through the above training manner, each first image in the first image collection can be used as self-supervised training data, to train the clustering module in the image semantic segmentation model in a self-supervised learning manner. That is, instead of manually annotating the first image, the image itself is used as self-supervised training data, thereby effectively using spatial consistency clustering information derived from self-supervision using a large number of images to obtain, through self-supervised training, clustering features with image spatial consistency from a large number of natural images, which effectively alleviates the dependence of a segmentation task on manual pixel-level fine annotation, so that the image semantic segmentation model can be scaled up for self-supervised training through a larger data set, improving the generalization performance of the image semantic segmentation model while reducing labor costs, and the trained clustering module can cluster regions having a spatial similarity relationship in an image into one class.

FIG. 4 is a schematic diagram of a clustering result of a clustering module according to an embodiment of the present disclosure. The left image is an original image, and the right image is an illustration of clustering regions obtained by using the trained clustering module. FIG. 4 shows that a dog is clustered into one clustering region, a rubber ball is clustered into one clustering region, and the background is clustered into one clustering region, which indicates that the trained clustering module can accurately perform clustering.

In some embodiments, the segmentation module in the image semantic segmentation model is a module for segmenting an image based on the image and a text description for the image. FIG. 5 is a flowchart of training a segmentation module in an image semantic segmentation model according to an embodiment of the present disclosure.

As shown in FIG. 5, first, in step S51, a second image in a second image collection is processed based on the clustering module in the image semantic segmentation model to obtain clustering regions of the second image.

The second image collection is a collection including a plurality of second images.

The second image collection may be an image collection identical to the first image collection. Alternatively, the second image collection may partially overlap with the first image collection. Alternatively, the second image collection may not overlap with the first image collection at all.

In this step, the second image in the second image collection may be processed using the trained clustering module to obtain the clustering regions of the second image. For example, for each second image in the second image collection, the trained clustering module encodes each second image to obtain an image feature corresponding to each second image, and process the image feature obtained through encoding (e.g., clustering image features based on a spatial similarity between the image features) to obtain clustering regions of each second image.

In step S52, a third image feature having a spatial coordinate index in the second image is obtained based on the second image, and a clustering feature of each of the clustering regions is obtained based on the third image feature.

The third image feature having the spatial coordinate index in the second image is a third image feature indexed with spatial coordinates in the second image.

The third image feature may be obtained by: for each second image, encoding the second image to obtain the third image feature indexed with the spatial coordinates in the second image.

The clustering feature of each of the clustering regions may be obtained by: first, determining, based on the spatial coordinate index, image features that are located in the same clustering region among the third image features; and then, calculating a mean value of the image features that are located in the same clustering region to obtain the clustering feature of each of the clustering regions. For example, it is assumed that the trained clustering module clusters the second image into three clustering regions: a clustering region 1, a clustering region 2, and a clustering region 3, and it is determined based on the spatial coordinate indexes that among the third image features, a feature 1, a feature 2, and a feature 3 are located in the clustering region 2, a feature 4 and a feature 5 are located in the clustering region 3, and a feature 6 and a feature 7 are located in the clustering region 1. A mean value of the feature 1, the feature 2, and the feature 3 may be calculated to obtain a clustering feature of the clustering region 2, a mean value of the feature 4 and the feature 5 may be calculated to obtain a clustering feature of the clustering region 3, and a mean value of the feature 6 and the feature 7 may be calculated to obtain a clustering feature of the clustering region 1.

In step S53, phrases (e.g., nouns) in the text description are extracted to obtain a text feature of each of the phrases. For example, a text feature of each of the phrases may be obtained by encoding each of the phrases.

In step S54, a cross-entropy loss between the clustering feature and the text feature is calculated.

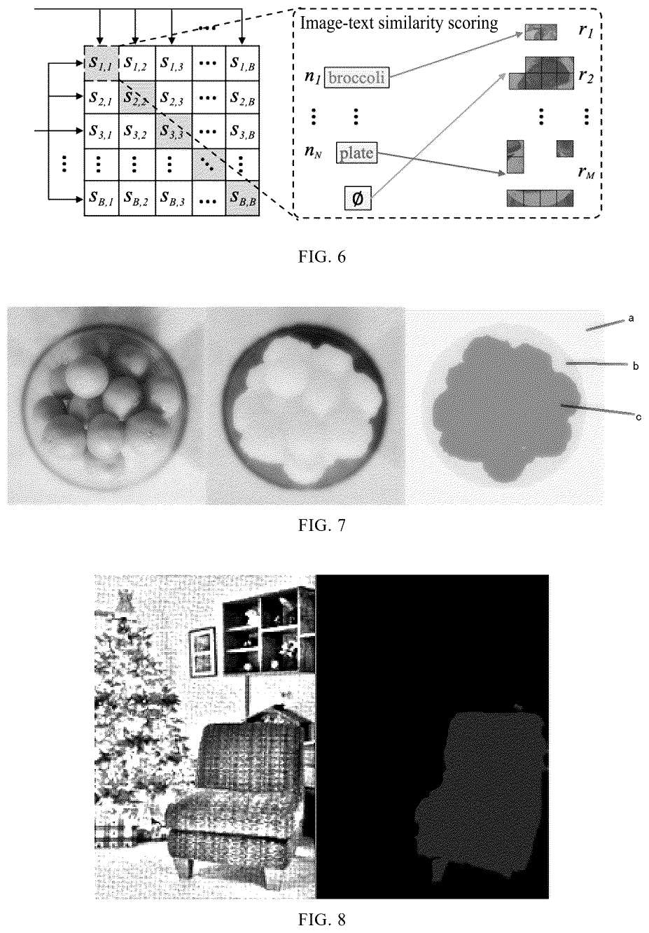

In some embodiments, a similarity between the text feature and each of the clustering features may be calculated by taking each of the text features as an object. For example, a similarity between the text feature and each of the clustering features may be obtained by calculating a Euclidean distance, a cosine distance, etc. between them. Then, a cross-entropy loss between the text feature and each of the clustering features is calculated based on the similarity. For example, the similarity between each of the text features and each of the clustering features may be constructed as a similarity matrix, and the cross-entropy loss may be calculated based on the similarity matrix. In this way, the text feature can be unidirectionally matched with the clustering feature, thereby unidirectionally matching the phrase in the text description with each of the clustering regions; and during learning of finer-grained image-text matching, a background and irrelevant regions in an image are filtered out, thereby effectively reducing background-class and noise clustering results among image segmentation results, making an image-text matching result more accurate, and reducing a large amount of mis-classification. FIG. 6 is a schematic diagram of unidirectionally matching phrases (e.g., nouns) with clustering regions according to an embodiment of the present disclosure. In FIG. 6, a similarity matrix constructed by similarities between text features and clustering features is shown on the left side, a schematic diagram of similarity scoring is shown on the right side, “broccoli” and “plate” represent nouns extracted from a text description, n₁, . . . , n_{N} represent text features corresponding to the nouns, and r₁, . . . , r_{M} represent clustering features corresponding to clustering regions. It can be learned from FIG. 6 that, during image-text matching, the text features are unidirectionally matched with the clustering features.

In step S55, the segmentation module is trained based on the cross-entropy loss to obtain a segmentation module in the image semantic segmentation model.

In some embodiments, the segmentation module may be trained by minimizing a cross-entropy loss between a text feature and each clustering feature.

The above technical solution has the following beneficial effects. The clustering module in the image semantic segmentation model processes each of the second images in the second image collection to obtain clustering regions of each of the second images, and a text description for each of the second images, each of the second image itself, and the clustering regions of each of the second images are used as training data for training the segmentation module in the image semantic segmentation model. Therefore, benefitting by comparative learning in the form of “image-text”, open vocabulary segmentation can be supported, and a segmentation result may be returned for any natural language input by a user.

FIG. 7 is a schematic diagram of an image segmentation result according to an embodiment of the present disclosure. The leftmost image is an image to be segmented, a text description input by a user is “a pile of oranges are placed on a plate on a table”, and a clustering result of a clustering module is an intermediate image. A segmentation module extracts nouns “orange”, “plate”, and “table” from the text description, matches these three nouns with the most corresponding clustering regions, and finally obtains a segmentation result shown in the rightmost image, where a region a is the table, a region b is the plate, and a region c is the orange. FIG. 7 shows a segmentation result for a plurality of objects in an image to be segmented. According to the present disclosure, a single object in an image to be segmented can also be segmented. As shown in FIG. 8, the left image is an image to be segmented, and when a text description of a user is “sofa”, an output segmentation result is shown in the right image in FIG. 8. The right image shows that the sofa is segmented.

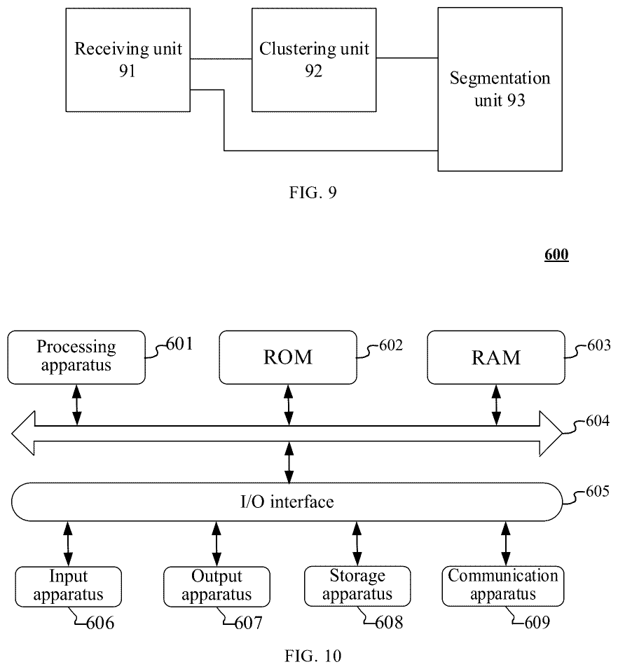

FIG. 9 is a schematic block diagram of an image segmentation apparatus according to an embodiment of the present disclosure. As shown in FIG. 9, the image segmentation apparatus includes: a receiving unit 91 configured to receive an image to be segmented input by a user and a text description for the image to be segmented; a clustering unit 92 configured to cluster, by using a clustering module in an image semantic segmentation model, regions having a spatial similarity relationship in the image to be segmented to obtain clustering regions; and a segmentation unit 93 configured to obtain a segmentation result by using a segmentation module in the image semantic segmentation model based on the text description, the image to be segmented, and the clustering regions.

The above technical solution has the following beneficial effects.
(1) Regions having a spatial similarity relationship in an image to be segmented are clustered into one class first, and then image-text segmentation is performed based on a clustering result, thereby effectively using spatial consistency clustering information in the image to be segmented, which can ensure accurate image semantic segmentation, solve the problems of excessive noise in a segmented image and inaccurate boundaries, and effectively alleviate the dependence of a segmentation task on manual pixel-level fine annotation, so that an image semantic segmentation model can be scaled up for self-supervised training through a larger data set, improving the generalization performance of the image semantic segmentation model while reducing labor costs, and downstream application deployment is not limited to limited scenarios of manual annotation, enabling more flexible large-scale application.
(2) Benefitting by segmentation in the form of “image-text”, open vocabulary segmentation can be supported, and a segmentation result may be returned for any natural language input by a user.

Optionally, the clustering module in the image semantic segmentation model is a module for clustering regions having a spatial similarity relationship in an image into one class, where the clustering module is trained by: performing spatial transformation on a first image in a first image collection to obtain a first spatially transformed image and a second spatially transformed image; encoding the first spatially transformed image and the second spatially transformed image separately to obtain a first image feature and a second image feature; calculating, by using a spatial consistency loss function, a loss between the first image feature and the second image feature; and training the clustering module based on the calculated loss to obtain the clustering module in the image semantic segmentation model.

Optionally, the encoding the first spatially transformed image and the second spatially transformed image separately to obtain a first image feature and a second image feature includes: encoding the first spatially transformed image and the second spatially transformed image separately to obtain the first image feature and the second image feature that are both indexed with spatial coordinates in the first image; and the calculating, by using a spatial consistency loss function, a loss between the first image feature and the second image feature includes: calculating, by using the spatial consistency loss function, a loss between image features that have the same spatial coordinate index among the first image features and the second image features.

Optionally, the spatial transformation is multi-scale and reversible.

Optionally, the segmentation module in the image semantic segmentation model is a module for segmenting an image based on the image and a text description for the image, and the segmentation module is trained by: processing each second image in a second image collection based on the clustering module in the image semantic segmentation model to obtain clustering regions of the second image; obtaining, based on the second image, a third image feature having a spatial coordinate index in the second image; obtaining, based on the third image feature, a clustering feature of each of the clustering regions; extracting phrases in the text description to obtain a text feature of each of the phrases; calculating a cross-entropy loss between the clustering feature and the text feature; and training the segmentation module based on the cross-entropy loss to obtain the segmentation module in the image semantic segmentation model.

Optionally, the obtaining, based on the third image feature, a clustering feature of each of the clustering regions includes: determining, based on the spatial coordinate index, image features that are located in the same clustering region among the third image features; and calculating a mean value of the image features that are located in the same clustering region to obtain the clustering feature of each of the clustering regions.

Optionally, the calculating a cross-entropy loss between the clustering feature and the text feature includes: taking each of the text features as an object, calculating a similarity between the text feature and each of the clustering features; and calculating, based on the similarity, the cross-entropy loss between the text feature and each of the clustering features.

The present disclosure further provides a computer-readable medium having a computer program stored thereon, where the program, when executed by a processing apparatus, causes the steps of the method according to any implementation of the present disclosure to be implemented.

The present disclosure further provides an electronic device, including: a storage having a computer program stored thereon; and a processing apparatus configured to execute the computer program in the storage to implement the steps of the method according to any implementation of the present disclosure.

Referring to FIG. 10 below, which is a schematic diagram of a structure of an electronic device 600 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic device shown in FIG. 10 is merely an example, and shall not impose any limitation on the function and scope of use of the embodiments of the present disclosure.

As shown in FIG. 10, the electronic device 600 may include a processing apparatus (e.g., a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a tape and a hard disk; and a communication apparatus 609. The communication apparatus 609 may allow the electronic device 600 to perform wireless or wired communication with other devices to exchange data. Although FIG. 10 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the hypertext transfer protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: receive an image to be segmented input by a user and a text description for the image to be segmented; cluster, by using a clustering module in an image semantic segmentation model, regions having a spatial similarity relationship in the image to be segmented to obtain clustering regions; and obtain a segmentation result by using a segmentation module in the image semantic segmentation model based on the text description, the image to be segmented, and the clustering regions.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The name of a module does not constitute a limitation on the module itself in some cases. For example, a clustering unit may also be described as “a module configured to cluster, by using a clustering module in an image semantic segmentation model, regions having a spatial similarity relationship in the image to be segmented to obtain clustering regions”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides an image segmentation method, including: receiving an image to be segmented input by a user and a text description for the image to be segmented; clustering, by using a clustering module in an image semantic segmentation model, regions having a spatial similarity relationship in the image to be segmented to obtain clustering regions; and obtaining a segmentation result by using a segmentation module in the image semantic segmentation model based on the text description, the image to be segmented, and the clustering regions.

According to one or more embodiments of the present disclosure, Example 2 provides the method of Example 1, where the clustering module in the image semantic segmentation model is a module for clustering regions having a spatial similarity relationship in an image into one class, where the clustering module is trained by: performing spatial transformation on a first image in a first image collection to obtain a first spatially transformed image and a second spatially transformed image; encoding the first spatially transformed image and the second spatially transformed image separately to obtain a first image feature and a second image feature; calculating, by using a spatial consistency loss function, a loss between the first image feature and the second image feature; and training the clustering module based on the calculated loss to obtain the clustering module in the image semantic segmentation model.

According to one or more embodiments of the present disclosure, Example 3 provides the method of Example 2, where the encoding the first spatially transformed image and the second spatially transformed image separately to obtain a first image feature and a second image feature includes: encoding the first spatially transformed image and the second spatially transformed image separately to obtain the first image feature and the second image feature that are both indexed with spatial coordinates in the first image; and
the calculating, by using a spatial consistency loss function, a loss between the first image feature and the second image feature includes: calculating, by using the spatial consistency loss function, a loss between image features that have the same spatial coordinate index among the first image features and the second image features.

According to one or more embodiments of the present disclosure, Example 4 provides the method of Example 2, where the spatial transformation is multi-scale and reversible.

According to one or more embodiments of the present disclosure, Example 5 provides the method of Example 1, where the segmentation module in the image semantic segmentation model is a module for segmenting an image based on the image and a text description for the image, and the segmentation module is trained by: processing each second image in a second image collection based on the clustering module in the image semantic segmentation model to obtain clustering regions of the second image; obtaining, based on the second image, a third image feature having a spatial coordinate index in the second image; obtaining, based on the third image feature, a clustering feature of each of the clustering regions; extracting phrases in the text description to obtain a text feature of each of the phrases; calculating a cross-entropy loss between the clustering feature and the text feature; and training the segmentation module based on the cross-entropy loss to obtain the segmentation module in the image semantic segmentation model.

According to one or more embodiments of the present disclosure, Example 6 provides the method of Example 5, where the obtaining, based on the third image feature, a clustering feature of each of the clustering regions includes: determining, based on the spatial coordinate index, image features that are located in the same clustering region among the third image features; and calculating a mean value of the image features that are located in the same clustering region to obtain the clustering feature of each of the clustering regions.

According to one or more embodiments of the present disclosure, Example 7 provides the method of Example 5, where the calculating a cross-entropy loss between the clustering feature and the text feature includes: taking each of the text features as an object, calculating a similarity between the text feature and each of the clustering features; and calculating, based on the similarity, the cross-entropy loss between the text feature and each of the clustering features.

According to one or more embodiments of the present disclosure, Example 8 provides an image segmentation apparatus, including: a receiving unit configured to receive an image to be segmented input by a user and a text description for the image to be segmented; a clustering unit configured to cluster, by using a clustering module in an image semantic segmentation model, regions having a spatial similarity relationship in the image to be segmented to obtain clustering regions; and a segmentation unit configured to obtain a segmentation result by using a segmentation module in the image semantic segmentation model based on the text description, the image to be segmented, and the clustering regions.

According to one or more embodiments of the present disclosure, Example 9 provides a computer-readable medium having a computer program stored thereon, where the program, when executed by a processing apparatus, causes the steps of the method of any of Examples 1 to 7 to be implemented.

According to one or more embodiments of the present disclosure, Example 10 provides an electronic device, including: a storage having a computer program stored thereon; and a processing apparatus configured to execute the computer program in the storage to implement the steps of the method of any of Examples 1 to 7.

The above descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. With respect to the apparatus in the above embodiments, the specific manner in which each module performs an operation has been described in detail in the embodiments relating to the method, and will not be detailed herein.

1. An image segmentation method, comprising:
receiving an image to be segmented input by a user and a text description for the image to be segmented;
clustering, by using a clustering module in an image semantic segmentation model, regions having a spatial similarity relationship in the image to be segmented to obtain clustering regions; and
obtaining a segmentation result by using a segmentation module in the image semantic segmentation model based on the text description, the image to be segmented, and the clustering regions.

2. The method of claim 1, wherein the clustering module in the image semantic segmentation model is a module for clustering regions having a spatial similarity relationship in an image into one class, wherein the clustering module is trained by:
performing spatial transformation on a first image in a first image collection to obtain a first spatially transformed image and a second spatially transformed image;
encoding the first spatially transformed image and the second spatially transformed image separately to obtain a first image feature and a second image feature;
calculating, by using a spatial consistency loss function, a loss between the first image feature and the second image feature; and
training the clustering module based on the calculated loss to obtain the clustering module in the image semantic segmentation model.

3. The method of claim 2, wherein encoding the first spatially transformed image and the second spatially transformed image separately to obtain the first image feature and the second image feature comprises: encoding the first spatially transformed image and the second spatially transformed image separately to obtain the first image feature and the second image feature that are both indexed with spatial coordinates in the first image; and
calculating, by using the spatial consistency loss function, the loss between the first image feature and the second image feature comprises: calculating, by using the spatial consistency loss function, a loss between image features that have the same spatial coordinate index among the first image features and the second image features.

4. The method of claim 2, wherein the spatial transformation is multi-scale and reversible.

5. The method of claim 1, wherein the segmentation module in the image semantic segmentation model is a module for segmenting an image based on the image and a text description for the image, and the segmentation module is trained by:
processing each second image in a second image collection based on the clustering module in the image semantic segmentation model to obtain clustering regions of the second image;
obtaining, based on the second image, a third image feature having a spatial coordinate index in the second image;
obtaining, based on the third image feature, a clustering feature of each of the clustering regions;
extracting phrases in the text description to obtain a text feature of each of the phrases;
calculating a cross-entropy loss between the clustering feature and the text feature; and
training the segmentation module based on the cross-entropy loss to obtain the segmentation module in the image semantic segmentation model.

6. The method of claim 5, wherein obtaining, based on the third image feature, the clustering feature of each of the clustering regions comprises:
determining, based on the spatial coordinate index, image features that are located in the same clustering region among the third image features; and
calculating a mean value of the image features that are located in the same clustering region to obtain the clustering feature of each of the clustering regions.

7. The method of claim 5, wherein calculating the cross-entropy loss between the clustering feature and the text feature comprises:
taking each of the text features as an object, calculating a similarity between the text feature and each of the clustering features; and
calculating, based on the similarity, the cross-entropy loss between the text feature and each of the clustering features.

8. (canceled)

9. A non-transitory computer-readable medium having a computer program stored thereon, wherein the computer program, when executed by a processor causes the processor to:
receive an image to be segmented input by a user and a text description for the image to be segmented;
cluster, by using a clustering module in an image semantic segmentation model, regions having a spatial similarity relationship in the image to be segmented to obtain clustering regions; and
obtain a segmentation result by using a segmentation module in the image semantic segmentation model based on the text description, the image to be segmented, and the clustering regions.

10. An electronic device, comprising a memory and a processor, wherein:
the memory comprises a computer program, when executed by a processor, causes the processor to:
receive an image to be segmented input by a user and a text description for the image to be segmented;
cluster, by using a clustering module in an image semantic segmentation model, regions having a spatial similarity relationship in the image to be segmented to obtain clustering regions; and
obtain a segmentation result by using a segmentation module in the image semantic segmentation model based on the text description, the image to be segmented, and the clustering regions.

11. The non-transitory computer-readable medium of claim 9, wherein the clustering module in the image semantic segmentation model is a module for clustering regions having a spatial similarity relationship in an image into one class, wherein the computer program comprises instructions to cause the processor to perform the following to train the clustering module:
perform spatial transformation on a first image in a first image collection to obtain a first spatially transformed image and a second spatially transformed image;
encode the first spatially transformed image and the second spatially transformed image separately to obtain a first image feature and a second image feature;
calculate, by using a spatial consistency loss function, a loss between the first image feature and the second image feature; and
train the clustering module based on the calculated loss to obtain the clustering module in the image semantic segmentation model.

12. The non-transitory computer-readable medium of claim 11, wherein the instructions that cause the processor to encode the first spatially transformed image and the second spatially transformed image separately to obtain the first image feature and the second image feature comprise instructions to cause the processor to: encode the first spatially transformed image and the second spatially transformed image separately to obtain the first image feature and the second image feature that are both indexed with spatial coordinates in the first image; and
the instructions that cause the processor to calculate, by using the spatial consistency loss function, the loss between the first image feature and the second image feature comprise instructions to cause the processor to: calculate, by using the spatial consistency loss function, a loss between image features that have the same spatial coordinate index among the first image features and the second image features.

13. The non-transitory computer-readable medium of claim 11, wherein the spatial transformation is multi-scale and reversible.

14. The non-transitory computer-readable medium of claim 9, wherein the segmentation module in the image semantic segmentation model is a module for segmenting an image based on the image and a text description for the image, wherein the computer program comprises instructions to cause the processor to perform the following to train the clustering module:
process each second image in a second image collection based on the clustering module in the image semantic segmentation model to obtain clustering regions of the second image;
obtain, based on the second image, a third image feature having a spatial coordinate index in the second image;
obtain, based on the third image feature, a clustering feature of each of the clustering regions;
extract phrases in the text description to obtain a text feature of each of the phrases;
calculate a cross-entropy loss between the clustering feature and the text feature; and
train the segmentation module based on the cross-entropy loss to obtain the segmentation module in the image semantic segmentation model.

15. The non-transitory computer-readable medium of claim 14, wherein the instructions that cause the processor to obtain, based on the third image feature, the clustering feature of each of the clustering regions comprise instructions to cause the processor to:
determine, based on the spatial coordinate index, image features that are located in the same clustering region among the third image features; and
calculate a mean value of the image features that are located in the same clustering region to obtain the clustering feature of each of the clustering regions.

16. The non-transitory computer-readable medium of claim 14, wherein the instructions that cause the processor to calculate the cross-entropy loss between the clustering feature and the text feature comprise instructions to cause the processor to:
take each of the text features as an object, calculating a similarity between the text feature and each of the clustering features; and
calculate, based on the similarity, the cross-entropy loss between the text feature and each of the clustering features.

17. The electronic device of claim 10, wherein the clustering module in the image semantic segmentation model is a module for clustering regions having a spatial similarity relationship in an image into one class, wherein the computer program comprises instructions to cause the processor to perform the following to train the clustering module:
perform spatial transformation on a first image in a first image collection to obtain a first spatially transformed image and a second spatially transformed image;
encode the first spatially transformed image and the second spatially transformed image separately to obtain a first image feature and a second image feature;
calculate, by using a spatial consistency loss function, a loss between the first image feature and the second image feature; and
train the clustering module based on the calculated loss to obtain the clustering module in the image semantic segmentation model.

18. The electronic device of claim 17, wherein the instructions that cause the processor to encode the first spatially transformed image and the second spatially transformed image separately to obtain the first image feature and the second image feature comprise instructions to cause the processor to: encode the first spatially transformed image and the second spatially transformed image separately to obtain the first image feature and the second image feature that are both indexed with spatial coordinates in the first image; and
the instructions that cause the processor to calculate, by using the spatial consistency loss function, the loss between the first image feature and the second image feature comprise instructions to cause the processor to: calculate, by using the spatial consistency loss function, a loss between image features that have the same spatial coordinate index among the first image features and the second image features.

19. The electronic device of claim 10, wherein the segmentation module in the image semantic segmentation model is a module for segmenting an image based on the image and a text description for the image, wherein the computer program comprises instructions to cause the processor to perform the following to train the clustering module:
process each second image in a second image collection based on the clustering module in the image semantic segmentation model to obtain clustering regions of the second image;
obtain, based on the second image, a third image feature having a spatial coordinate index in the second image;
obtain, based on the third image feature, a clustering feature of each of the clustering regions;
extract phrases in the text description to obtain a text feature of each of the phrases;
calculate a cross-entropy loss between the clustering feature and the text feature; and
train the segmentation module based on the cross-entropy loss to obtain the segmentation module in the image semantic segmentation model.

20. The electronic device of claim 19, wherein the instructions that cause the processor to obtain, based on the third image feature, the clustering feature of each of the clustering regions comprise instructions to cause the processor to:
determine, based on the spatial coordinate index, image features that are located in the same clustering region among the third image features; and
calculate a mean value of the image features that are located in the same clustering region to obtain the clustering feature of each of the clustering regions.

21. The electronic device of claim 19, wherein the instructions that cause the processor to calculate the cross-entropy loss between the clustering feature and the text feature comprise instructions to cause the processor to:
take each of the text features as an object, calculating a similarity between the text feature and each of the clustering features; and
calculate, based on the similarity, the cross-entropy loss between the text feature and each of the clustering features.
